(19) United States
(12) Patent Application Publication
(10) Pub. No.: US 2026/0302786 A1
(43) Pub. Date: Oct. 1, 2026

(54) SYSTEMS AND METHODS FOR VOLTAGE-BASED CURRENT LIMITING

(71) Applicant: Cummins Inc., Columbus, IN (US)

(72) Inventors: Michael James Scheuerell, Stillwater, MN (US); Jordan Loos, Columbus, IN (US); Lane Woodland, Cannelton, IN (US); Jeff Martin, Columbus, IN (US); Fei Gong, Redmond, WA (US); Mugdha S. Sane, Columbus, IN (US)

(21) Appl. No.: 19/095,728

(22) Filed: Mar. 31, 2025

(51) Int. Cl. H02J 3/32; H02J 7/00

(52) U.S. Cl. CPC H02J 3/32; H02J 7/64; H02J 2207/20

(57) ABSTRACT

A system and method of controlling voltage in a power system by automatically manipulating current with a power conversion device in response to a measured voltage value within the power system meeting or exceeding at least one predetermined threshold. The power conversion device may also automatically disconnect from the power system when the measured voltage value meets or exceeds an over-voltage protection threshold. Current manipulation and disconnect from the power system may occur without receiving a command from a supervisory controller.

### TECHNICAL FIELD OF THE PRESENT DISCLOSURE

The present disclosure relates to systems and methods for limiting voltage in a power system. In particular, the present disclosure relates to power conversion devices configured to limit voltage in a power system.

### BACKGROUND OF THE PRESENT DISCLOSURE

Environmental and efficiency considerations have resulted in the electrification of vehicles across industries and purposes. While electric and hybrid passenger and cargo vehicles are becoming more commonplace, electrification and/or hybridization of large equipment vehicles poses its own set of challenges. For example, large equipment vehicles, such as mining trucks, cranes, bulldozers, etc. may require a workload and/or have a sheer size component that make implementation of alternative powertrains more difficult. Additionally, the power and environmental requirements of such vehicles during operation complicates efficient operative implementation of alternative powertrains.

Battery electric and/or hybrid vehicles typically include direct current (DC) power sources such as one or more batteries to provide power for the respective vehicle. Components and/or systems of the vehicles, such as, for example, traction motors, drive motors, electronic and electrical systems, etc. may use different DC supply voltages. DC-DC converters may be included to buck or boost the battery voltage and to control power flow into and out of the one or more batteries. For example, a DC-DC converter may step up or down energy storage voltage to match with a common DC bus voltage.

### SUMMARY OF THE DISCLOSURE

A system and method of controlling voltage in a power system by automatically manipulating current with a power conversion device in response to a measured voltage value within the power system meeting or exceeding at least one predetermined threshold. The power conversion device may also automatically disconnect from the power system when the measured voltage meets or exceeds an over-voltage protection threshold. Current manipulation and disconnect from the power system may occur without receiving a command from a supervisory controller.

In a first aspect of the disclosure, a system for limiting voltage is disclosed. The system includes a power source configured to provide power to a power network of the system; a power conversion device connecting the power source to the power network; and a controller connected to the power conversion device. The controller is configured to transmit a current command to the power conversion device to maintain a steady current within the power conversion device. The power conversion device is configured to override the current command received by the controller and automatically alter current within the power conversion device in response to a measured voltage of the power system meeting or exceeding a predetermined voltage threshold.

In a second aspect of the disclosure, a power system is disclosed. The power system includes a power source; a power network; and a power conversion device configured to connect the power source and the power network. The power conversion device includes a first state in which the power conversion device maintains a steady current; a second state in which a measured voltage meets or exceeds a first voltage threshold and the power conversion device increases current in response; and a third state in which the measured voltage meets or exceeds a second voltage threshold and the power conversion device decreases current in response.

In a third aspect of the disclosure, a method for limiting voltage is disclosed. The method includes measuring a change in voltage within a power system, the power system including a power conversion device; automatically increasing current using the power conversion device in response to a measured voltage meeting or exceeding a first threshold; automatically decreasing current using the power conversion device in response to the measured voltage meeting or exceeding a second threshold; and automatically disconnecting the power conversion device in response to the measured voltage meeting or exceeding a third threshold.

In various aspects of the disclosure, the power source may include a battery system.

In various aspects of the disclosure, the power conversion device may be configured to revert to the transmitted current command of the controller when the measured voltage of the power system is within a normal operation zone which does not meet or exceed the predetermined voltage threshold.

In various aspects of the disclosure, the predetermined voltage threshold includes a first predetermined voltage threshold defined in part by a preselected maximum voltage value and a second predetermined voltage threshold defined in part by a preselected minimum voltage value. The power conversion device may be configured to automatically decrease current in response to the measured voltage meeting or exceeding the first predetermined voltage threshold. The power conversion device may be configured to automatically increase current in response to the measured voltage meeting or exceeding the second predetermined voltage threshold.

In various aspects of the disclosure, the power conversion device may be configured to automatically disconnect from the power system in response to the measured voltage of the power system meeting or exceeding an over-voltage protection threshold greater than the predetermined voltage threshold.

In various aspects of the disclosure, the power conversion device may be configured to automatically change from any of the first state, the second state, and the third state to any other of the first state, the second state, and the third state in response to a change in the measured voltage.

In various aspects of the disclosure, the power conversion device may further include a fourth state in which the measured voltage meets or exceeds a third voltage threshold and the power conversion device disconnects from the power system.

In various aspects of the disclosure, the first voltage threshold may be determined by a preselected minimum voltage value and a preselected low voltage value.

In various aspects of the disclosure, the first voltage threshold and the second voltage threshold may be separated by a zone of normal operation in which the power conversion device is in the first state.

In various aspects of the disclosure, the method may further include returning to a steady state in which the power conversion device maintains a steady current in response to the measured voltage no longer meeting or exceeding the first threshold.

In various aspects of the disclosure, the method may further include returning to a steady state in which the power conversion device maintains a steady current in response to the measured voltage no longer meeting or exceeding the second threshold.

In various aspects of the disclosure, measuring a change in voltage within a power system may occur in response to a sudden change in current downstream of the power system from the power conversion device.

In various aspects of the disclosure, the method may further include maintaining a steady current with the power conversion device in response to a command received by a controller in response to the measure voltage meeting or exceeding none of the first threshold, the second threshold, and the third threshold. The first threshold and the second threshold may be separated by a zone of normal operation in which the power conversion device maintains a steady current.

In various aspects of the disclosure, the first threshold may be defined by a line of interpolation between a preselected minimum voltage value at a 0% charge current and a preselected low voltage value at a 100% charge current when the power system is in a charging state.

In various aspects of the disclosure, the second threshold may be defined by a line of interpolation between a preselected maximum voltage at a 0% discharge current and a preselected high voltage value at a 100% discharge current when the power system is in a discharging state.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The detailed description of the drawings particularly refers to the accompanying figures in which:

FIG. 1 is a schematic illustration of a hybrid electric or electric vehicle;

FIG. 2 is a schematic illustration of a power system of a vehicle;

FIG. 3 is an illustration of an exemplary voltage map; and

FIG. 4 is an flow chart illustrating a method of limiting current within a power system.

Although the drawings represent embodiments of various features and components according to the present disclosure, the exemplification set out herein illustrates an embodiment, and such an exemplification is not to be construed as limiting the scope of the disclosure in any manner.

### DETAILED DESCRIPTION OF THE DRAWINGS

For the purposes of promoting an understanding of the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, fourth, etc., is used in reference to various components of features. Such use is not intended to denote an ordering of the components or features. Rather, numeric terminology is used to assist the reader in identifying the components or features being referenced and should not be narrowly interpreted as providing a specific order of components or features.

As used herein “battery system” refers to any collection of batteries, including battery packs, battery modules, battery cells, etc., for operation of a battery or hybrid powertrain.

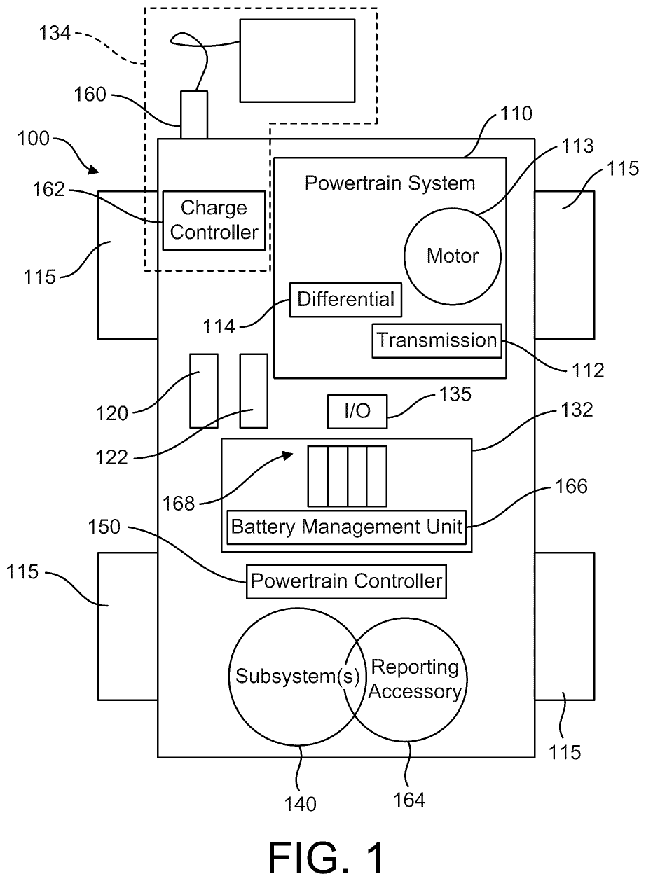

FIG. 1 illustrates a schematic diagram of a vehicle 100 which may use one or more power converters as discussed further herein. Although the exact embodiment shown and described herein relative to FIG. 1 is most similar to that of a battery electric vehicle, vehicle 100 and the embodiments discussed in accordance with this disclosure may be used in any other appropriate application, such as, for example, vehicles with alternative hybrid powertrains and/or vehicles such as locomotives and large equipment vehicles including mining trucks and/or construction equipment.

In other words, while the vehicle illustrated in FIG. 1 is most similar to a battery electric vehicle, it is understood that vehicle 100 may be generally interchanged with a hybrid vehicle, such as a plug-in hybrid vehicle or another hybrid vehicle, which is powered or otherwise operable via a battery system and, optionally, one or more of a generator (e.g., a power generator, generator plant, electric power strip, on-board rechargeable electricity storage system, etc.) and a motor (e.g., an electric motor, traction motor, etc.) For example, a hybrid DC power supply may be used to provide multiple supply voltages from a single alternator and converter, for example, in vehicles requiring both 12V and 48V power supplies.

Vehicle 100 may be operable in at least one of a reverse direction (e.g., a backward direction relative to a front end of vehicle 100) and a non-reverse direction (e.g., a forward direction, angular direction, etc., relative to the front end of vehicle 100). Vehicle 100 may be an on-road or off-road vehicle including, but not limited to, cars, trucks, ships, boats, vans, airplanes, spacecraft, or any other type of vehicle.

Vehicle 100 may include a powertrain controller 150 communicably and operatively coupled to a powertrain system 110, a brake mechanism 120, an accelerator pedal 122, one or more sensors, an operator input/output (I/O) device 135, and one or more additional vehicle subsystems 140. Vehicle 100 may include additional, fewer, and/or different components systems than depicted in FIG. 1, such that the principles, methods, systems, apparatuses, processes, and the like of the present disclosure are intended to be applicable with any suitable vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

Powertrain system 110 may facilitate power transfer from a battery 132 or battery system and/or a motor 113 to power vehicle 100. In some embodiments, powertrain 110 may include motor 113 operably coupled to battery 132 and charge system 134, where motor 113 transfers power to a final drive (e.g., wheels 115) to propel vehicle 100. As depicted, powertrain system 110 may include other various components, such as a transmission 112 and/or differential 114, where differential 114 transfers power output from transmission 112 to final drive 115 to propel vehicle 100.

Powertrain controller 150 of vehicle 100 provides electricity to motor 113 (e.g., an electric motor) in response to various inputs received by powertrain controller 150, for example, from accelerator pedal 122, sensors, vehicle subsystems 140, charge system 134 (e.g., a battery charging system rechargeable battery, etc.). In some embodiments, electricity provided to power motor 113 and/or electrical components of subsystems 140 may be provided by an onboard gasoline-engine generator, a hydrogen fuel cell, a hybrid DC power source, etc.

In some embodiments, vehicle 100 may include a transmission 112. Transmission 112 may be structured as any type of transmission compatible with vehicle 100, including a continuous variable transmission, a manual transmission, an automatic transmission, an automatic-manual transmission, or a dual clutch transmission, for example. As transmissions vary from geared to continuous configurations, transmission 112 may include a variety of settings (e.g., gears, for a geared transmission) that affect different output speeds based on an engine speed or motor speed.

Like transmission 112, motor 113, differential 114, and final drive 115 may be structured in any configuration compatible with vehicle 100. In some embodiments, transmission 112 is omitted and motor 113 is directly coupled to differential 114. In other embodiments, motor 113 may be directly coupled to final drive 115 as a direct drive application. In some examples, vehicle 100 may include multiple instances of motor 113, for example, one instance for each driven wheel, one instance per driven axle, or other compatible arrangements.

Brake mechanism 120 may be implemented as a brake (e.g., hydraulic disc brake, drum brake, air brake, etc.), braking system, or any other device configured to prevent or reduce motion by slowing or stopping components (e.g., a wheel, axle, pedal, crankshaft, driveshaft, etc. of vehicle 100). Generally, brake mechanism 120 is configured to receive an indication of a desired change in the vehicle speed.

In some embodiments, brake mechanism 120 includes a brake pedal operable between a released state and an applied state by an operator of vehicle 100. The brake pedal may be configured as a pressure-based system responsive to applied pressure or a travel-based system responsive to a travel distance of the pedal, where a force applied to brake mechanism 120 is proportional to the pressure and/or travel distance. In some embodiments, all or a portion of brake mechanism 120 is incorporated into motor 113, for example, as a regenerative brake mechanism.

Generally, the released state of brake mechanism 120 corresponds to a brake pedal in a default location where the brake mechanism is not applied, for example, when the operator's foot is not placed on the brake pedal at all or merely resting on the brake pedal such that a minimum actuation force is not exceeded (e.g., a spring-assisted, hydraulic-assisted, or servo-assisted force that pushes the brake pedal to the default location).

In some embodiments, the brake pedal is combined with accelerator pedal 122 in a one-pedal driving configuration. In some examples, the applied state of brake mechanism 120 may correspond to the brake pedal being pressed with a force that meets or exceeds the minimum actuation force. In other examples, the applied state of brake mechanism 120 corresponds to the brake pedal being pressed so that the travel distance of the brake pedal meets or exceeds a minimum travel distance.

Generally, the minimum actuation force and/or minimum travel distance help to prevent accidental actuation of brake mechanism 120. Different levels of the minimum actuation force and/or minimum travel distance may be used for different implementations of brake mechanism 120, for example, relatively higher forces or travel distance for a foot-actuated brake pedal and/or relatively lower forces or travel distance for a hand-actuated brake lever. Although the brake pedal may have a range of pressures and/or travel distances that provide at least some braking effect on vehicle 100 (e.g., high pressures for hard or emergency braking, lower pressures for gradual braking or “feathering” the brakes), this range of pressures and/or travel distances are within the applied state.

The released state may correspond to an indication of a desired increase in vehicle speed, while the applied state may correspond to an indication of a desired reduction in vehicle speed. In some embodiments, a reduction in actuation force and/or travel distance corresponds to a desired increase in vehicle speed, while an increase in actuation force and/or travel distance corresponds to a desired reduction in vehicle speed.

Accelerator pedal 122 may be structured as any type of torque and/or speed request device included with a system (e.g., a floor-based pedal, an acceleration lever, paddle or joystick, etc.). Sensors associated with accelerator pedal 122 and/or brake mechanism 120 may include a vehicle speed sensor that provides a vehicle speed signal corresponding to a vehicle speed of vehicle 100, an accelerator pedal position sensor that acquires data indicative of a depression amount of the pedal (e.g., a potentiometer), a brake mechanism sensor that acquires data indicative of a depression amount (pressure or travel) of brake mechanism 120, a coolant temperature sensor, a pressure sensor, an ambient air temperature, or other suitable sensors.

Vehicle 100 may include operator I/O device 135. Operator I/O device 135 may enable an operator of the vehicle to communicate with vehicle 100 and/or powertrain controller 150. Analogously, operator I/O device 135 enables vehicle 100 and/or powertrain controller 150 to communicate with the operator. For example, operator I/O device 135 may include, but is not limited to, an interactive display (e.g., a touchscreen) having one or more buttons, input devices, haptic feedback devices, an accelerator pedal, a brake pedal, a shifter, or other interface for transmission 112, a cruise control input setting, a navigation input setting, or other settings or adjustments available to the operator. Via operator I/O device 135, powertrain controller 150 may also provide commands, instructions, and/or information to the operator or a passenger.

Vehicle 100 includes one or more vehicle subsystems 140, which may generally include one or more sensors (e.g., a speed sensor, ambient pressure sensor, temperature sensor, etc.), as well as any other subsystem that may be included with a vehicle. Vehicle subsystems 140 may also include torque sensors for one or more of motor 113, transmission 112, differential 114, and/or final drive 115.

Other vehicle subsystems 140 may include a steering subsystem for managing steering functions, such as electrical power steering, and output information such as wheel position and fault codes corresponding to steering battery electric vehicle 100; an electrical subsystem which may include audio and visual indicators, such as hazard lights and speakers configured to emit audible warnings, as well as other functions; and a thermal management system, which may include components such as a radiator, coolant, pumps, fans, heat exchangers, computing devices, and associated software applications. Vehicle 100 may include further sensors other than those otherwise discussed herein, such as cameras, LIDAR, and/or RADAR, temperature sensors, smoke detectors, virtual sensors, among other potential sensors.

Powertrain controller 150 may be communicably and operatively coupled to powertrain system 110, brake mechanism 120, accelerator pedal 122, operator I/O device 135, and one or more vehicle subsystems 140. Communication between and among the components may be via any number of wired or wireless connections. For example, a wired connection may include a serial cable, a fiber optic cable, an SAE J1939 bus, a CAT5 cable, or any other form of wired connection.

In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information, and/or data.

Powertrain controller 150 is structured to receive data (e.g., instructions, commands, signals, values, etc.) from one or more of the components of vehicle 100 as described herein via the communicable coupling of powertrain controller 150 to the systems and components of vehicle 100. In some embodiments, an additional or alternative controller may be used for receiving data from certain systems or components.

In vehicles including charge system 134, such as a plug-in charging system, powertrain controller 150 may control charging of battery 132 when a charger of charge system 134 is connected to vehicle 100 A charge controller 162 may establish communication between powertrain controller 150 and charger 160. Charge controller 162 may monitor sensor signals and perform safety and performance checks and determine faults based thereon. For example, charge controller 162 may determine a fault if charging has started but a physical connection between charger 160 and vehicle 100 fails to be detected or is detected to be outside safe boundaries. In other words, charge controller 162 may function as a communication interface between charger 160 and powertrain controller 150.

Powertrain controller 150 may be communicably coupled with charger 160, battery 132, and a reporting accessory 164 so that digital data may be transferred between components. Reporting accessory 164 may be included with a vehicle subsystem 140 or another vehicle component. A CAN bus may be implemented to provide communication capabilities. In some embodiments, a first CAN bus may be implemented to provide communications between a first plurality of components while a second CAN bus may be implemented to provide communications between a second plurality of components. Any series or parallel communication scheme and protocol known in the art may be implemented to provide communication.

Reporting accessory 164 may be operable to communicate information to powertrain controller 150. Such information may include identification, current demand, high or low voltage power draw, and other information required for operation of vehicle 100. Identification information may include a maximum current capacity of reporting accessory 164, for example. The current demand may be dynamic, such that the current demanded by reporting accessory 164 varies.

Reporting accessory 164 may include an air-conditioning system, for example, and the current demand may vary based on a measured actual temperature of an interior of vehicle 100 compared to a target temperature. By reporting current demand to powertrain controller 150, reporting accessory 164 enables powertrain controller 150 to more accurately determine the target current to generate the charge command to charger 162.

Comparatively, when the load of a non-reporting accessor is dynamic and unknown, charger 162 may underdeliver current to battery 132, extending charging time. The charge command may also take into account the charger's capability to deliver current and indicates to charger 162 the level of current to output to vehicle 100, which is ideally sufficient to optimally charge battery 132 and also power the accessories.

Battery 132 may include one or more battery packs including a battery management unit 166 and battery modules 168. FIG. 1 is not determinative of the number of battery modules within a battery pack or the number of battery packs within battery 132. Battery 132 may include a greater number of battery packs and/or a grater or lesser number of battery modules. Temperature, voltage, and other sensors may be provided to enable battery management unit 166 to manage the charging and discharging of battery modules 168 without exceeding their limits, to detect and manage faults, and to perform other known functions.

Battery management unit 166 may transmit data to powertrain controller 150 related to information about battery 132, including the battery charge power limit, temperature, faults, etc. Battery 132 may include a current sensor to provide a measured current value to battery management unit 166, which may be used to affect the charge command provided to charger 162. The current sensor may be located elsewhere. Multiple current sensors may be used, each current sensor associated with a battery module of battery 132, with the sum of the measured currents being the measured current of battery 132.

Powertrain controller 150 may include a charge logic operable to determine a command for charger 162 to supply a target current to battery 132. The charge logic may also be integrated with a controller of battery management unit 166 or provided in a standalone controller communicatively coupled to powertrain controller 150. In other words, powertrain controller 150 may also transmit data to battery management unit 166. The term “logic” as used herein includes software and/or firmware comprising processing instructions executing on one or more programmable processors, application-specific integrated circuits, field-programmable gate arrays, digital signal processors, hardwired logic, or combinations thereof, which may be referred to as “controllers”. As such, various logic may be implemented in any appropriate fashion.

A non-transitory machine-readable medium comprising logic may be included within any tangible form of a computer-readable carrier, such as a solid-state memory, containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash), or any tangible medium capable of storing information.

A transport control system and charging system may communicatively connect multiple charger and control charging processes in a depot, linking charging points, power supplies, and operational information systems, such as planning and scheduling systems. The transport control system may provide the charging management system information, such as estimated arrival time of vehicles, time available for charging, and scheduled pull-out time. The charging management system may then calculate the charging requirements for each vehicle and optimize charging processes for the fleet of vehicles to, for example, avoid expensive grid peak load periods where possible.

The charging management system may also assign time slots for charging to each vehicle and monitor progress of charging of each vehicle. The charging management system may receive, from each vehicle, an estimated time to full charge. In other embodiments, the vehicle may provide the relevant data to the charging management system, which may then estimate the time to full charge within its control logic.

As described above, although FIG. 1 most closely resembles a battery electric vehicle, the disclosure provided herein may also apply to vehicles having other powertrains, such as, for example, a plug-in hybrid vehicle or another hybrid vehicle or vehicle with alternative powertrain. In such embodiments, the vehicle may optionally include an engine, which may be structured as an internal combustion engine that receives a chemical energy input (e.g., a fuel such as natural gas, gasoline, ethanol, or diesel) from a fuel delivery system and combusts the fuel to generate mechanical energy in the form of a rotating crankshaft. In such an embodiment, the transmission receives the rotating crankshaft and manipulates the speed of the crankshaft (e.g., the engine speed, which is usually expressed in revolutions-per-minute (RPM)) to affect a desired draft shaft speed. A rotating drive shaft may be received by the differential, which provides the rotation energy from the drive shaft to the final drive, which then propels or moves the vehicle.

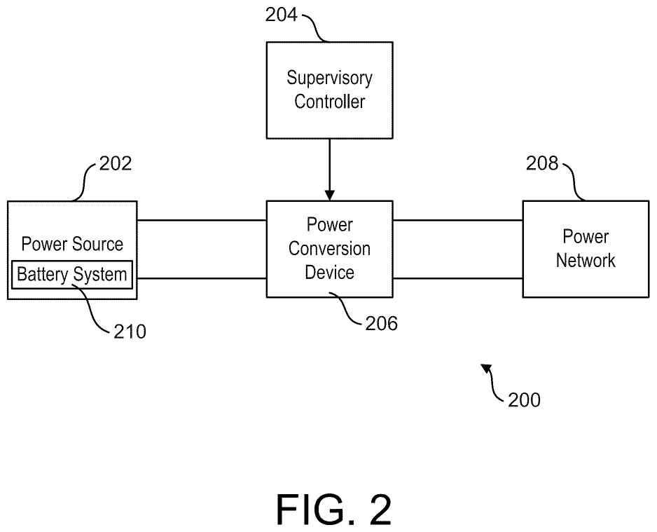

Referring to FIG. 2, power systems including batteries, such as power system 200, may provide power to a variety of systems and subsystems and/or store power for later use. For example, hybrid electric vehicles, electric vehicles, generators, storage of renewable energy for later use, and energy storage on a grid for various purposes (e.g., grid stability, peak shaving, renewable energy time shifting, etc.) may use and/or involve battery systems (e.g., power source 202). Often, the state of charge (SOC) and state of health (SOH) is estimated and monitored to track the available capacity and overall health of the battery system. For example, SOC may be defined as the available capacity of an individual battery and/or battery system, expressed as a percentage of the rated capacity. SOH may represent a measure of the battery's ability to store and deliver electrical energy, compared with a new battery.

SOC and SOH may facilitate description of performance of the respective battery and/or battery system and help predict its future behavior. Estimation of SOC and SOH may include consideration of numerous factors and parameters. For example, age, cycle life (number of charge/discharge cycles), capacity, internal resistance, energy throughput, temperature, self-discharge rate, and/or voltage may be considered when evaluating the SOH of a battery and/or battery system.

With passage of time, batteries and/or battery systems may generally age and degrade, resulting in the respective SOH dropping below its initial level. Batteries and/or battery systems with a lower SOH may discharge much faster than batteries and/or battery systems with a comparatively greater SOH due to a predictable decline in the rated capacity occurring over time.

Battery chemistry, voltage, current, capacity, impedance, charging/discharging rate, and temperature of a battery and/or battery system may be considered when evaluating the SOC of the respective battery and/or battery system. The SOC illustrates the amount of electric charge left in the battery, usually expressed as a percentage that ranges from 0% to 100% depending on the charge level. Charging/discharging requirements include voltage, current, and temperature limits, and going beyond these limits may lead to battery damage.

A battery management system, or controller 204, may be used to ensure safe, effective, and ideal operation of batteries by monitoring and/or controlling SOC and SOH by monitoring and controlling their usage. For example, as discussed above, monitoring SOC and SOH may involve measuring the battery and/or battery system's voltage, current, and temperature. The controller 204 may use these results to determine the SOC and/or SOH and use the information to mitigate the chances of overcharge and/or overdischarge of the battery and/or battery system, which may result in permanent damage to the battery and/or battery system.

Such battery systems may use voltage-balancing devices, systems, and methods which may include the use of one or more DC-DC converters (e.g., power conversion device 206) connected to one or more batteries. In some embodiments, a DC-DC converter may be connected to one battery or multiple batteries to form a battery circuit. In other embodiments, multiple battery circuits may be connected in parallel to a common DC bus. Some DC-DC converters may facilitate isolation of each battery in the battery circuit from other batteries or battery circuits by controlling current flows. In larger systems, multiple DC-DC converters may work in concert.

For example, still referring to FIG. 2, a schematic of power system 200 is illustrated. Power system 200 may include power source 202, including at least a battery system 210 and/or an internal combustion engine in hybrid vehicle embodiments. Power conversion device 206 is connects power source 202 to a power network 208, which may include a number of vehicle systems or subsystems which requires conversion of power from power source 202 for proper and safe operation of the connected systems or subsystems within power network 208. Power conversion device 206 may be a DC-DC converter as described above, an AC-DC converter, or an AC-AC converter. A controller 204 transmits instructions to power conversion device 206 to facilitate operation of power conversion device 206.

As discussed above, controller 204 may command a current to power conversion device 206 so that power conversion device 206 maintains the commanded current on its output terminals, i.e., a fixed current arrangement. Under a fixed current arrangement, if the current downstream of power conversion device 206 suddenly changes, the voltage within power network 208, including within power conversion device 206 and power source 202, may rapidly changes in response.

Events which may cause a sudden current change may include, for example, a sudden change in load on a circuit within power network 208 downstream of power conversion device 206, a fault in circuitry within power network 208 downstream of power conversion device 206, a malfunction of power conversion device 206, a fluctuation in power input from power source 202, or environmental factors which may affect the performance of power system 200 and/or its components. Other factors may cause a sudden current change downstream of power conversion device 206 in some embodiments.

A rapid change in voltage as described above may lead to damage of power system 200 and/or its components and/or reduced performance of power system 200. To mitigate undesirable results of a rapid change in voltage, power conversion device 206 may override the current control function of controller 204 in response to the change in voltage to maintain the voltage level of power system 200 within an acceptable range, as described further herein.

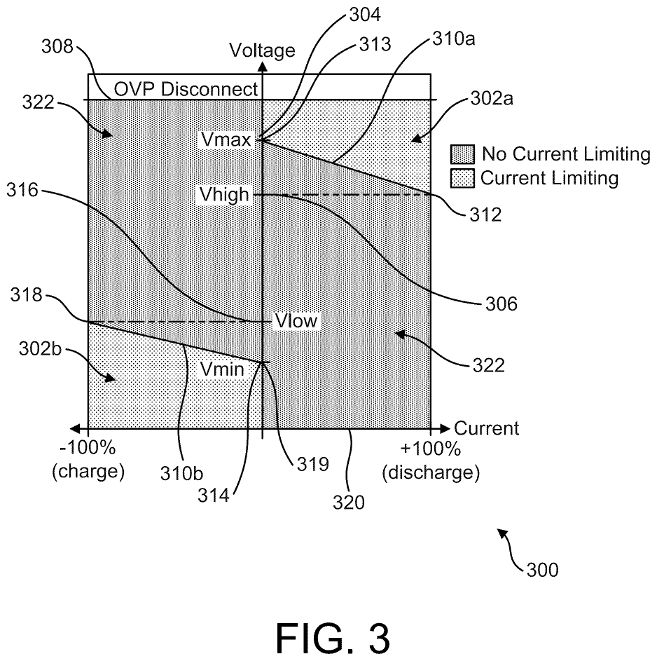

For example, referring additionally to FIG. 3, power conversion device 206 may be configured to override the current command received from controller 204 when a measured voltage of power conversion device 206 is within a current limiting zone 302a, 302b of voltage map 300. Voltage map 300 generally maps voltage of power system 200 and/or power conversion device 206 where voltage is mapped along the y-axis and current is mapped along the x-axis.

Upper current limiting zone 302a is defined by a predetermined maximum voltage threshold (Vₘₐₓ 304), a predetermined high voltage threshold (V_{high} 306), and an over-voltage protection threshold (OVP 308) when battery system 210 is being discharged at a rate above 0%. As used herein, “predetermined” includes any parameter provided by an input, including parameters which are set prior to operation or parameters which are adjusted dynamically during operation by an operator or controller, such as controller 204.

For example, Vₘₐₓ 304 is a preselected threshold selected and/or adjusted by an operator or controller, such as controller 204, in view of suitable operation levels of the relevant system. For example, in some applications, a Vₘₐₓ threshold level may be suitably selected at a higher value than in other applications. Factors in selecting Vₘₐₓ 304 may include the type of power source 202, SOC and/or SOH of battery system 210, voltage ratings of affected systems, operating mode of the vehicle, and other factors. Vₘₐₓ 304 may be selected at a level at which alteration of current and/or voltage level may mitigate the chance of damage to power system 200, but at which damage to power system 200 is threatened and/or operation of power system 200 may be compromised.

In some embodiments, Vₘₐₓ 304 may be selected at a particular voltage value. In other embodiments, Vₘₐₓ 304 may be selected as a function of a maximum voltage of battery system 210 or a component thereof. For example, in some embodiments, Vₘₐₓ 304 may substantially equal the maximum voltage of battery system 210 or a component thereof; in other embodiments, Vₘₐₓ 304 may include the maximum voltage of battery system 210 or a component thereof plus a margin voltage amount.

In some embodiments, Vₘₐₓ 304 may be selected according to the direction in which current flows through power conversion device 306. In other words, within single power system 200, Vₘₐₓ 304 may be a first preselected threshold when current flows in a first direction and a second preselected threshold when current flows in a second direction. In other embodiments, Vₘₐₓ 304 may not substantially vary regardless of direction of current flow.

V_{high} 306 is a preselected threshold selected by an operator or controller, such as controller 204, in view of suitable operation levels of the relevant system. For example, in some applications, a V_{high} threshold level may be suitable selected at a higher value than in other applications. Factors in selecting V_{high} 306 may include the type of power source 202, SOC and/or SOH of battery system 210, capacity of battery system 210, and other factors. V_{high} 306 may be selected at a value at which, at some discharge levels, there is no or little threat of damage to power system 200 and, at other discharge levels, damage to power system 200 is threatened and/or operation of power system 200 may be compromised but may be mitigated with alteration to the current and/or voltage level.

In some embodiments, V_{high} 306 may be selected at a particular voltage value. In other embodiments, V_{high} 304 may be selected as a function of a maximum voltage of battery system 210 or a component thereof. For example, in some embodiments, V_{high} 306 may substantially equal the maximum voltage of battery system 210 or a component thereof; in other embodiments, V_{high} 306 may include the maximum voltage of battery system 210 or a component thereof plus a margin voltage amount. Generally, V_{high} 306 has a value that is less than the value of Vₘₐₓ 304.

In some embodiments, V_{high} 306 may be selected according to the direction in which current flows through power conversion device 206. In other words, within single system 200, V_{high} 306 may be a first preselected threshold when current flows in a first direction and a second preselected threshold when current flows in a second direction. In other embodiments, V_{high} 306 may not substantially vary regardless of direction of current flow.

OVP 308 may be selected at a level beyond which damage to power system 200 is inevitable and/or operation of power system 200 is compromised. When a voltage level of power system 200 reaches OVP 308, power conversion device 206 disconnects from power system 200 to stop power flow.

A line of interpolation 310a extends from the intersection 312 of V_{high} 306 and 100% discharge current to the intersection 313 of Vₘₐₓ 306 and 0% discharge current so that upper current limiting zone 302a is defined between line of interpolation 310a and OVP 308 on the y-axis and between 0% discharge current, 100% discharge current, and line of interpolation 310a on the x-axis.

Lower current limiting zone 302b is defined by a predetermined minimum voltage threshold (Vₘᵢₙ 314) and a predetermined low voltage threshold (V_{low} 316) when battery system 210 is being charged at a rate above 0%.

For example, Vₘᵢₙ 314 is a preselected threshold selected by an operator or controller, such as controller 204, in view of suitable operation levels of the relevant system. For example, in some applications, a Vₘᵢₙ threshold level may be suitably selected at a lower value than in other applications. Factors in selecting Vₘᵢₙ 314 may include the type of power source 202, SOC and/or SOH of battery system 210, capacity of battery system 210, and other factors. Vₘᵢₙ 314 may be selected at a level at which alteration of current and/or voltage level may mitigate the chance of damage to power system 200, but at which damage to power system 200 is threatened and/or operation of power system 200 may be compromised.

In some embodiments, Vₘᵢₙ 314 may be selected at a particular voltage value. In other embodiments, Vₘᵢₙ 314 may be selected as a function of a maximum voltage of battery system 210 or a component thereof. For example, in some embodiments, Vₘᵢₙ 314 may substantially equal the minimum voltage of battery system 210 or a component thereof; in other embodiments, Vₘᵢₙ 314 may include the minimum voltage of battery system 210 or a component thereof plus a margin voltage amount.

In some embodiments, Vₘᵢₙ 314 may be selected according to the direction in which current flows through power conversion device 306. In other words, within single power system 200, Vₘᵢₙ 314 may be a first preselected threshold when current flows in a first direction and a second preselected threshold when current flows in a second direction. In other embodiments, Vₘᵢₙ 314 may not substantially vary regardless of direction of current flow.

V_{low} 316 is a preselected threshold selected by an operator or controller, such as controller 204, in view of suitable operation levels of the relevant system. For example, in some applications, a V_{low} threshold level may be suitable selected at a lower value than in other applications. Factors in selecting V_{low} 316 may include the type of power source 202, SOC and/or SOH of battery system 210, capacity of battery system 210, and other factors. V_{low} 316 may be selected at a value at which, at some discharge levels, there is no or little threat of damage to power system 200 and, at other discharge levels, damage to power system 200 is threatened and/or operation of power system 200 may be compromised but may be mitigated with alteration to the current and/or voltage level.

In some embodiments, V_{low} 316 may be selected at a particular voltage value. In other embodiments, V_{low} 316 may be selected as a function of a minimum voltage of battery system 210 or a component thereof. For example, in some embodiments, V_{low} 316 may substantially equal the minimum voltage of battery system 210 or a component thereof; in other embodiments, V_{low} 316 may include the minimum voltage of battery system 210 or a component thereof plus a margin voltage amount. Generally, V_{low} 316 has a value that is greater than the value of Vₘᵢₙ 314.

In some embodiments, V_{low} 316 may be selected according to the direction in which current flows through power conversion device 206. In other words, within single system 200, V_{low} 316 may be a first preselected threshold when current flows in a first direction and a second preselected threshold when current flows in a second direction. In other embodiments, V_{low} 316 may not substantially vary regardless of direction of current flow.

A line of interpolation 310b extends from the intersection 318 of V_{low} 316 and 100% charge current to the intersection 319 of Vₘᵢₙ 314 and 0% charge current so that lowercurrent limiting zone 302b is defined between line of interpolation 310b and 0V 320 on the y-axis and between 0% charge current, 100% charge current, and line of interpolation 310b on the x-axis.

As discussed further herein, when the measured voltage of power system 200, e.g., the measured voltage within power conversion device 206, is within current limiting zones 302a, 302b, power conversion device 206 automatically reacts by overriding the instructions received from controller 204 to either rise or lower the current within power conversion device 206, thereby lowering the voltage within power conversion device 206 and power system 200.

The area of voltage map 300 outside of OVP 308 and current limiting zones 302a, 302b is a normal operation zone 322, in which power system 200 operates as normal, e.g., power conversion device 206 operates according to the command(s) received from controller 204.

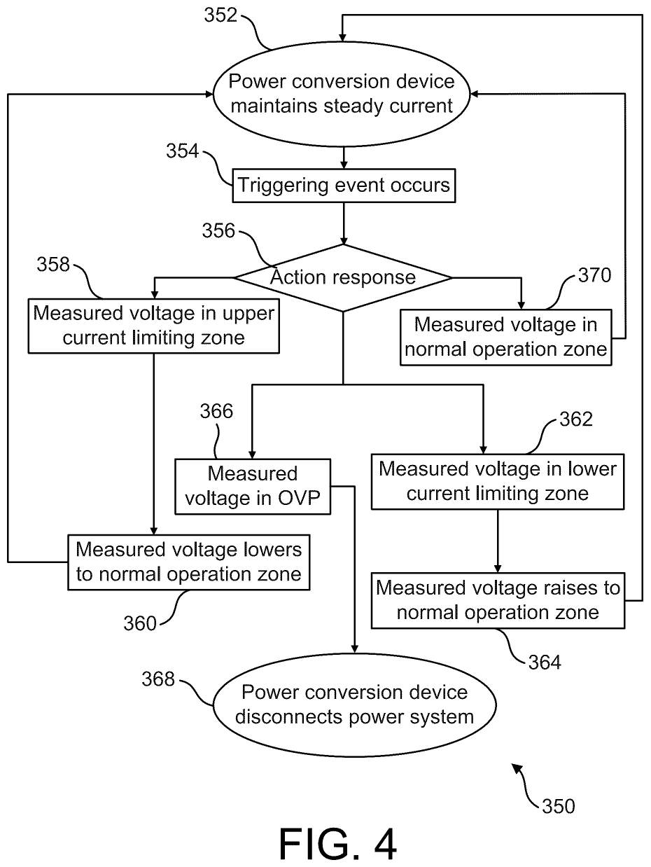

Now referring to FIG. 4 in view of FIGS. 2-3, a method 350 of limiting current within power system 200 is provided. At the beginning of method 350 (e.g., box 352), power conversion device 206 maintains a steady current on its terminals during operation. This continues until power conversion device 206 shuts down or power system 200 experiences a triggering event as described further herein.

At box 354, a triggering event occurs causing the voltage of power system 200 to rapidly change in response. The triggering event may be a sudden current change within power system 200, for example, downstream of power conversion device 206, which may result from a sudden change in load on a circuit within power network 208 downstream of power conversion device 206, a fault in circuitry within power network 208 downstream of power conversion device 206, a malfunction of power conversion device 206, a fluctuation in power input from power source 202, or environmental factors which may affect the performance of power system 200 and/or its components. Other factors may cause a sudden current change in some embodiments.

At box 356, power conversion device 206 automatically takes one of four action depending on a measured voltage of power system 200. The measured voltage of power system 200 may be measured, for example, at power conversion device 206. In other words, power conversion device 206 measures the voltage of power system 200 or otherwise receives the measured voltage of power system 200.

For example, if the measured voltage of power system 200 is within upper current limiting zone 302a, that is, referring to FIG. 3, if the measured voltage of power system 200 is between line of interpolation 310a and OVP 308 on the y-axis and between 0% discharge current, 100% discharge current, and line of interpolation 310a on the x-axis at box 358, power conversion device 206 overrides the current command received from controller 204 and automatically lowers the current within power conversion device 206. Because current and voltage are directly related, lowering the current within power conversion device 206 also lowers the voltage within power conversion device 206. At box 360, the measured voltage passes out of upper current limiting zone 302a into normal operation zone 322, and power conversion device 206 reverts to normal operation-i.e., according to command(s) received from controller 204.

If the measured voltage of power system 200 is within lower current limiting zone 302b, that is, referring to FIG. 3, if the measured voltage of power system 200 between line of interpolation 310b and 0V 320 on the y-axis and between 0% charge current, 100% charge current, and line of interpolation 310b on the x-axis at box 362, power conversion device 206 overrides the current command received from controller 204 and automatically raises the current within power conversion device 206. Because current and voltage are directly related, raising the current within power conversion device 206 also raises the voltage within power conversion device 206. At box 364, the measured voltage passes out of lower current limiting zone 302b into normal operation zone 322, and power conversion device 206 reverts to normal operation-i.e., according to command(s) received from controller 204.

If the measured voltage of power system 200 meets or exceeds OVP 308 at box 366, power conversion device 206 overrides the current command received from controller 204 and automatically disconnects to stop the flow of current through power system 200 at box 368.

If the measured voltage of power system 200 remains within normal operation zone 322 at box 370, power conversion device 206 maintains normal operation-i.e., according to command(s) received from controller 204.

The ability of power conversion device 206 to automatically override command(s) from controller 204 to control the current and, thereby, the voltage within power conversion device 206 and/or power system 200 allows for a rapid response to a rapid change in voltage which may otherwise cause damage to power system 200 and/or components thereof or otherwise compromise operation of power system 200.

For example, the ability of power conversion device 206 to control voltage indirectly via current rather than control voltage directly allows power conversion device 206 to immediately respond to a rapid change in voltage rather than delay such response by switching configurations from a current-controlling configuration to a voltage-controlling configuration. Similarly, the ability of power conversion device 206 to immediately respond to a rapid change in voltage avoids delays which may result from awaiting a change in command(s) from controller 204.

While the system and methods herein have been described by reference to various specific embodiments it should be understood that numerous changes may be made within the spirit and scope of the concepts described, accordingly, it is intended that the invention is not limited to the described embodiments but will have full scope defined by the language of the following claims.

What is claimed is:

1. A system for limiting voltage, the system comprising:
a power source configured to provide power to a power network of the system;
a power conversion device connecting the power source to the power network; and
a controller connected to the power conversion device and configured to transmit a current command to the power conversion device to maintain a steady current within the power conversion device;
wherein the power conversion device is configured to override the current command received by the controller and automatically alter current within the power conversion device in response to a measured voltage of the power system meeting or exceeding a predetermined voltage threshold.

2. The system of claim 1, wherein the power source includes a battery system.

3. The system of claim 1, wherein the power conversion device is configured to revert to the transmitted current command of the controller when the measured voltage of the power system is within a normal operation zone which does not meet or exceed the predetermined voltage threshold.

4. The system of claim 1, wherein the predetermined voltage threshold includes a first predetermined voltage threshold defined in part by a preselected maximum voltage value and a second predetermined voltage threshold defined in part by a preselected minimum voltage value.

5. The system of claim 4, wherein the power conversion device is configured to automatically decrease current in response to the measured voltage meeting or exceeding the first predetermined voltage threshold; and
the power conversion device is configured to automatically increase current in response to the measured voltage meeting or exceeding the second predetermined voltage threshold.

6. The system of claim 1, wherein the power conversion device is configured to automatically disconnect from the power system in response to the measured voltage of the power system meeting or exceeding an over-voltage protection threshold greater than the predetermined voltage threshold.

7. A power system, the power system comprising:
a power source;
a power network; and
a power conversion device configured to connect the power source and the power network, the power conversion device having:
a first state in which the power conversion device maintains a steady current;
a second state in which a measured voltage meets or exceeds a first voltage threshold and the power conversion device increases current in response; and
a third state in which the measured voltage meets or exceeds a second voltage threshold and the power conversion device decreases current in response.

8. The power system of claim 7, wherein the power conversion device is configured to automatically change from any of the first state, the second state, and the third state to any other of the first state, the second state, and the third state in response to a change in the measured voltage.

9. The power system of claim 7, the power conversion device further having a fourth state in which the measured voltage meets or exceeds a third voltage threshold and the power conversion device disconnects from the power system.

10. The power system of claim 7, wherein the first voltage threshold is determined by a preselected maximum voltage value and a preselected high voltage value.

11. The power system of claim 7, wherein the second voltage threshold is determined by a preselected minimum voltage value and a preselected low voltage value.

12. The power system of claim 7, wherein the first voltage threshold and the second voltage threshold are separated by a zone of normal operation in which the power conversion device is in the first state.

13. A method for limiting voltage, the method comprising:
measuring a change in voltage within a power system including a power conversion device;
automatically increasing current using the power conversion device in response to a measured voltage meeting or exceeding a first threshold;
automatically decreasing current using the power conversion device in response to the measured voltage meeting or exceeding a second threshold; and
automatically disconnecting the power conversion device in response to the measured voltage meeting or exceeding a third threshold.

14. The method of claim 13, further comprising returning to a steady state in which the power conversion device maintains a steady current in response to the measured voltage no longer meeting or exceeding the first threshold.

15. The method of claim 13, further comprising returning to a steady state in which the power conversion device maintains a steady current in response to the measured voltage no longer meeting or exceeding the second threshold.

16. The method of claim 13, wherein measuring a change in voltage within a power system occurs in response to a sudden change in current downstream of the power system from the power conversion device.

17. The method of claim 13, further comprising maintaining a steady current with the power conversion device in response to a command received by a controller in response to the measured voltage meeting or exceeding none of the first threshold, the second threshold, and the third threshold.

18. The method of claim 17, wherein the first threshold and the second threshold are separated by a zone of normal operation in which the power conversion device maintains a steady current.

19. The method of claim 13, wherein the first threshold is defined by a line of interpolation between a preselected minimum voltage value at a 0% charge current and a preselected low voltage value at a 100% charge current when the power system is in a charging state.

20. The method of claim 13, wherein the second threshold is defined by a line of interpolation between a preselected maximum voltage at a 0% discharge current and a preselected high voltage value at a 100% discharge current when the power system is in a discharging state.
